(19) United States
(12) Patent Application Publication
(10) Pub. No.: US 2009/0060231 A1
(43) Pub. Date: Mar. 5, 2009

(54) Bone Conduction Headphones

(76) Inventor: Thomas William Buroojy, Newtown, PA (US)

Correspondence Address: FISH & RICHARDSON P.C., P.O. BOX 1022, MINNEAPOLIS, MN, 55440-1022, US

(21) Appl. No.: 12/167,786

(22) Filed: Jul. 3, 2008

Related U.S. Application Data
(60) Provisional application No. 60/958,499, filed on Jul. 6, 2007.

(51) Int. Cl. H04R 25/00; H04R 1/10

(52) U.S. Cl. 381/151; 381/380; 381/381; 381/120

(57) ABSTRACT

A stereo headphone includes a first audio element and a second audio element to be positioned against sides of a user's head in which each of the first and second audio elements is configured to transmit audio signals through bone to the auditory system of the user.

### RELATED APPLICATIONS

This application is related to and claims priority to U.S. Provisional Patent Application No. 60/958,499, filed Jul. 6, 2007, the contents of which are incorporated by reference in its entirety.

### BACKGROUND

This disclosure relates to bone conduction headphones.

The use of traditional earphones and ear-buds, for listening to music and other audio content, hinders the ability of persons to detect ambient sound in their environment as they perform daily activities or take part in other pursuits such as walking, running, skiing, driving, skating, biking, or working. Because the earphones or ear-buds cover or are within a person's ear canal, it can be difficult to hear sounds such as a car driving nearby, an automobile or train's horn, sirens, or communication from other people. In addition, earphones and ear-buds often can be used at volumes that damage a person's hearing. Accordingly, headphones and ear-buds present a significant safety hazard.

### SUMMARY

This application relates to bone conduction hearing devices. More specifically this application relates to bone conduction hearing devices for use with personal audio devices, individual communications systems, personal protective headgear, or individual garments.

In an implementation of the present invention, a piezoelectric transducer is coupled to an amplifying circuit and an audio source. The piezoelectric transducer can be housed in one or more layers of insulating material. The piezoelectric transducer can be arranged to be worn by a user. The piezoelectric transducer can be integrated into a helmet, glasses or other head gear.

In another implementation a stereo headphone system is provided. The stereo headphone system comprises first audio element positioned against a first side of a user's head, and a second audio element to be positioned against a second side of a user's head. The first and second audio elements are configured to transmit audio signals through bone or other bodily tissue to the auditory system of the user. The first and second audio elements can comprise a piezoelectric device.

In yet another implementation a stereo headphone system is provided comprising a first audio element positionable against a first side of a user's head, and a second audio element positionable against a second side of a user's head. The first and second audio elements are configured to transmit audio signals through bone or other bodily tissue to the auditory system of the user. The first and second audio elements can comprise a piezoelectric device. The first and second audio elements can be coupled to an amplifier circuit wherein the amplifier circuit amplifies an electrical signal received from an audio device. The amplifier circuit can further comprise a receiver circuit for wirelessly receiving audio signals from the audio device. The amplifier circuit can have its own power source, such as a battery. The amplifier circuit can be coupled to a solar power source.

In still a further implementation the stereo headphone system can be integral to headgear, headwear, eye protection, eyewear, a helmet, goggles, night-vision goggles, glasses, hat, headband, garment or clothing. The first and second audio elements can be integral to a helmet, goggles, night-vision goggles, glasses, hat, headband, garment or clothing.

In yet another implementation the stereo headphone system can further include first and second audio elements configured to be removable from headgear, headwear, eye protection, eyewear, a helmet, goggles, night-vision goggles, glasses, hat, headband, garment or clothing.

### DESCRIPTION OF DRAWINGS

FIG. 1 is an illustration of an ear.

FIG. 2 illustrates an example of a way to use a bone conduction device.

FIG. 3 illustrates an example of a bone conduction device.

FIG. 4A illustrates an example of a bone conduction device.

FIG. 4B illustrates an example of an amplifier circuit.

FIG. 5 illustrates an example of an amplifier circuit.

FIG. 6A illustrates an example of an amplifier circuit and an audio device.

FIG. 6B illustrates an example of a connector for an amplifier circuit.

FIG. 7 illustrates an example of an amplifier circuit coupled to a computer device.

FIG. 8 illustrates an example of a way to send audio signals to the bone conduction device.

FIG. 9 shows a block diagram.

FIG. 10 is an example schematic of an amplifier circuit.

FIG. 11 shows an example of a coupling means.

FIG. 12A shows an example of a bone conducting device integrated with a microphone headset.

FIG. 12B shows an example of a bone conducting device integrated with a microphone headset.

FIG. 13 shows an example of a bone conducting device integrated with a helmet.

FIG. 14 illustrates an example of a removable attachment for a bone conducting device.

FIG. 15 illustrates an example of a removable attachment for a bone conducting device.

FIG. 16 illustrates an example of a bone conducting device integrated with sunglasses.

### DETAILED DESCRIPTION

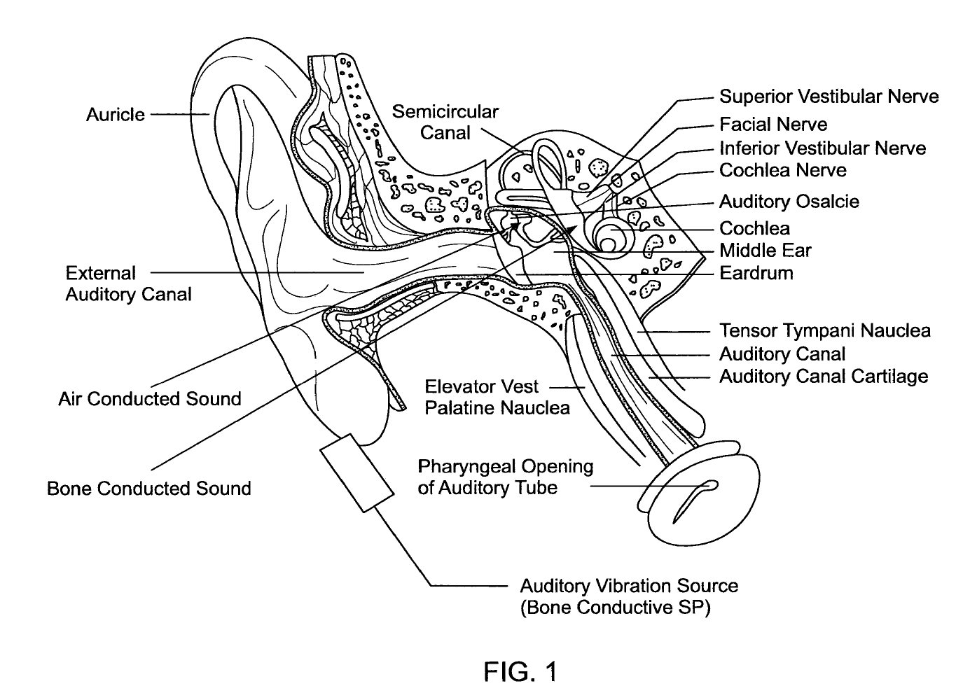

Typically, people hear sound from sound waves that enter through the ear and strike the ear drum as shown in FIG. 1. The ear drum converts the sound wave into a physical vibration of the ear drum and transmits that physical vibration to the cochlea bone and auditory system. The cochlea converts the vibrations into signals carried by nerve cells to the brain. However, sound also can be recognized from vibrations that reach the auditory system without passing through the ear canal and ear drum. For example, as also shown in FIG. 1, the sound can pass through the bones of the head to the auditory system, or cochlea. The process of passing sound through bones to the auditory system is called bone conduction.

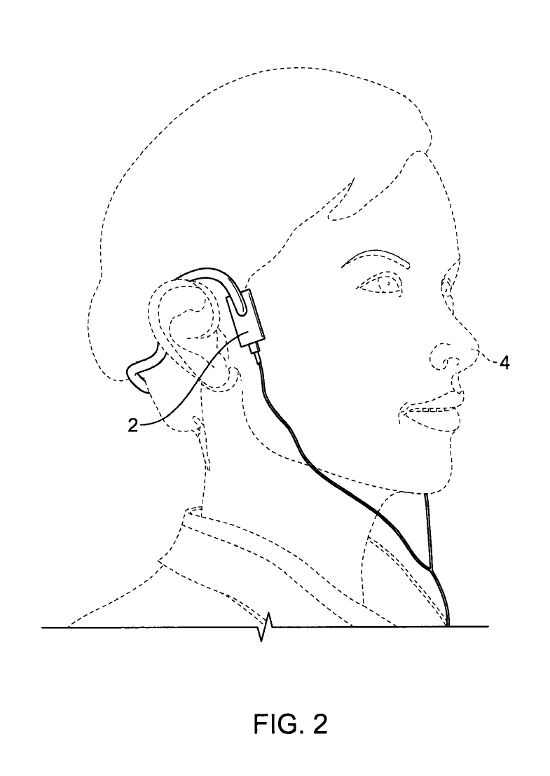

An example of a bone conduction headset device 2 that allows users to listen to audio signals while, at the same time, keeping ear canals open is shown placed around a user's head in FIG. 2. The bone conduction device 2 can be connected to any audio device capable of producing sound such as a portable music player, a portable video player, a portable gaming device, a cellular telephone, a communication system such as a radio transceiver, a stereo systems, and the like. An example of a portable music player is a portable digital music player or MP3 device, such as the iPod™, manufactured by Apple Inc., of Cupertino, Calif. An example of a portable gaming system is the Sony PlayStation® Portable game device, manufactured by Sony Computer Entertainment America Inc., of Foster City, Calif.

Using bone conduction headset device 2, the user 4 detects sound as a result of vibrations that pass from the bone conduction device 2 through the user's facial tissue and jaw or skull bone to the user's inner ear. At the same time, the bone conduction device 2 does not cover the user's ear canal. In this way, the user 4 can listen to the audio signals from the device 2 while also hearing ambient sounds. The effect is similar to, for example, a user listening to a car radio while simultaneously taking part in a conversation. In addition, persons who work or are near locations where excessive sound occurs, such as industrial sites, can protect their ears using ear plugs or other sound reducing devices, while still listening to their audio device.

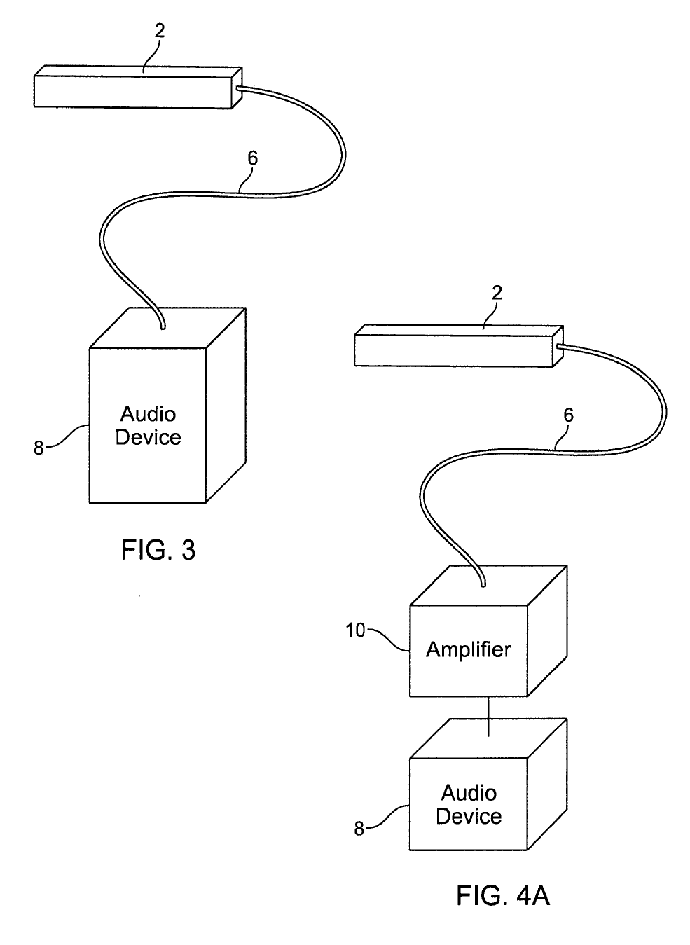

The bone conduction device 2 is formed from a piezoelectric transducer that takes electrical signals from an audio device and converts them to vibrations. The bone conduction device 2 can be a simple thin plate housing the piezoelectric transducer that is placed against a user's head such as the example device illustrated in FIG. 3. In an implementation, the thin plate housing the piezoelectric transducer can be wholly or partially encased in one or more insulating materials. For example, the thin plate housing the piezoelectric transducer can be sandwiched between two layers of insulating material. The insulating material can be configured to optimally deliver sound to the user, such as filtering certain interfering frequencies that may produce undesirable sound characteristics (e.g. high frequency tininess). The insulating material can also prevent sound leakage from the device to the ambient surroundings.

The device 2 can be coupled to a flexible cable 6 for electrically connecting to an audio device 8. Alternatively, the device 2 can incorporate a means of wirelessly transmitting and receiving data and audio signals from the audio device 8, such as blue tooth technology.

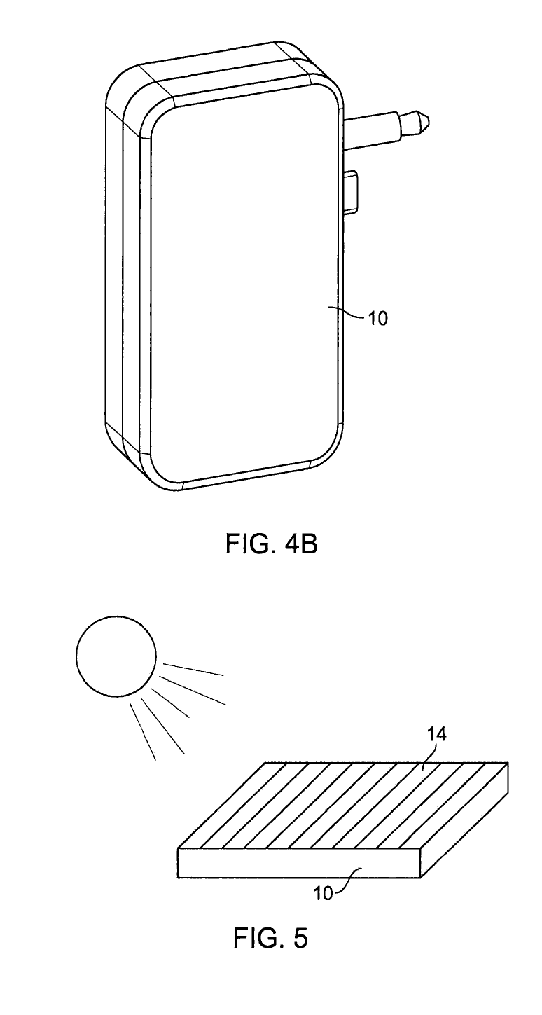

In some implementations, the flexible cable couples the bone conduction device 2 to an amplifier circuit 10, as shown in FIG. 4A, for amplifying signals produced by the audio device 8 and driving the piezoelectric elements of the bone conduction device 2. Preferably, the amplifier circuit 10 is formed compact and compatible with the user's audio device 8. An example of an amplifier circuit is shown in FIG. 4B. Referring again to FIG. 4A, the flexible cable 6 can be coupled to the amplifier circuit 10 using a standard 4 contact 3.5 mm headphone jack although other means of connection also may be used. Similarly, the amplifier circuit 10 can be coupled to the audio device 8 using a standard headphone jack, wire or other connection means. The amplifier circuit 10 is powered using one or more batteries that include, for example, lithium ion batteries, alkaline batteries, nickel metal hydride batteries, or nickel cadmium batteries. Other batteries may be used as well. An amplifier circuit 10 that uses batteries can be recharged by means of a universal serial bus (USB) connector that attaches to a computer or other electronic device. Alternatively, the batteries can be recharged by means of a cable connecting the device to a car charger or AC wall outlet. In some implementations, the amplifier circuit 10 is powered using an external power source such as a car charger, AC wall outlet, a computer USB port or the audio device 8 itself. Alternatively, in some implementations, the amplifier circuit is powered using solar cells 14. As shown in FIG. 5, the cells 14 can be placed on an outer casing that covers the amplifier circuit 10 and use light to power or recharge the battery in the amplifier 10.

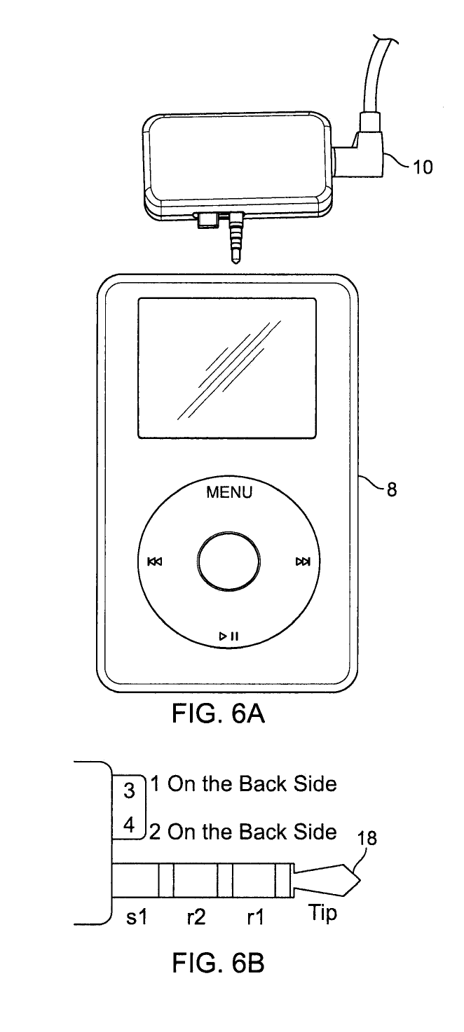

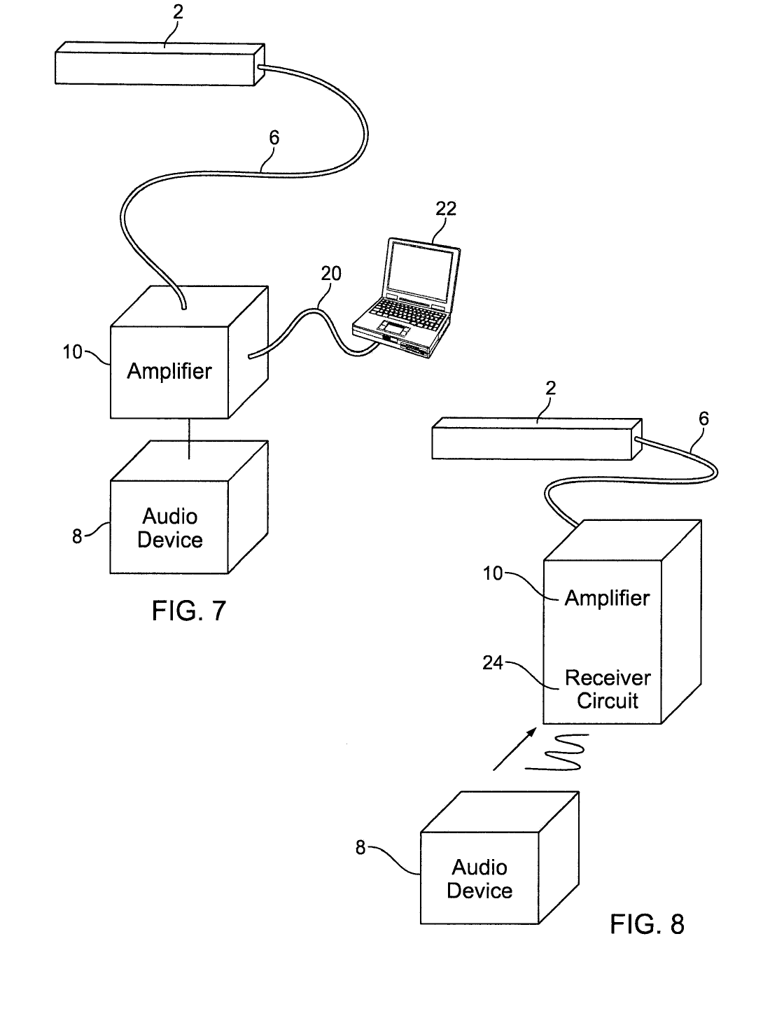

In a first embodiment, the amplifier circuit 10 is powered and recharged by the audio device 8 itself. FIG. 6A shows an example of connecting the amplifier circuit to an audio device 8 such as an iPod™. In this embodiment, the amplifier circuit 10 includes a connector that receives power from a 3.3 volt (V) accessory port on the iPod™ for powering the amplifier circuit 10. In addition, the amplifier circuit 10 includes an audio jack 18 for receiving the audio output of the iPod™ (see FIG. 6B). The audio device 8 is not limited to iPods™ but includes any audio device that has ports for audio signals and voltage supplies such as a PlayStation®, PlayStation® Portable, a mobile or cellular phone, a smart phone such as the Apple iPhone™, personal digital assistant (PDA), or any digital audio player. In addition, the voltage used to power the amplifier circuit 10 is not limited to 3.3 V but can include any voltage appropriate for operating the circuit 10. In another embodiment, the amplifier circuit 10 includes a single audio jack 18 such as a 4 connector 3.5 mm audio jack for acquiring audio signals from a generic audio port. The amplifier circuit 10 can be powered by a lithium-ion battery that can be recharged by a USB connector 20 that couples to an electronic device 22 such as a computer (see FIG. 7).

In another embodiment, the amplifier circuit 10 includes a receiver circuit 24 for receiving audio signals wirelessly using, for example, Bluetooth® wireless technology. The amplifier circuit 10 then takes the received audio signals and amplifies them to drive the piezoelectric members of the bone conducting device 2 (see FIG. 8). In this way, the amplifier circuit 10 can be integrated as part of the bone conducting device 2 and does not require the use of wires to connect to the audio device 8. An amplifier circuit 10 that uses a wireless receiver can be powered using rechargeable batteries such as a lithium-ion battery or any other battery capable of powering the amplifier circuit 10 and receiver circuit 24.

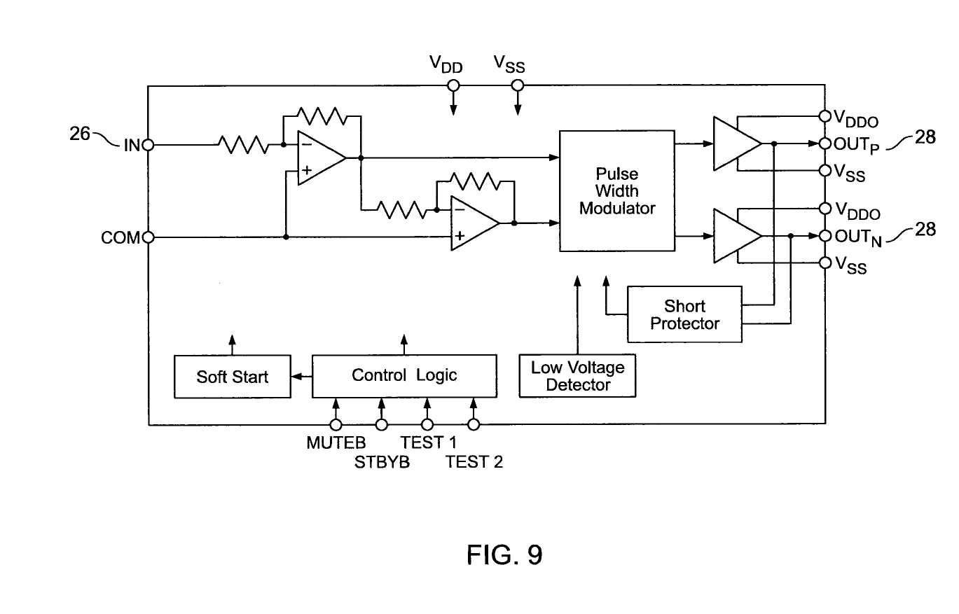

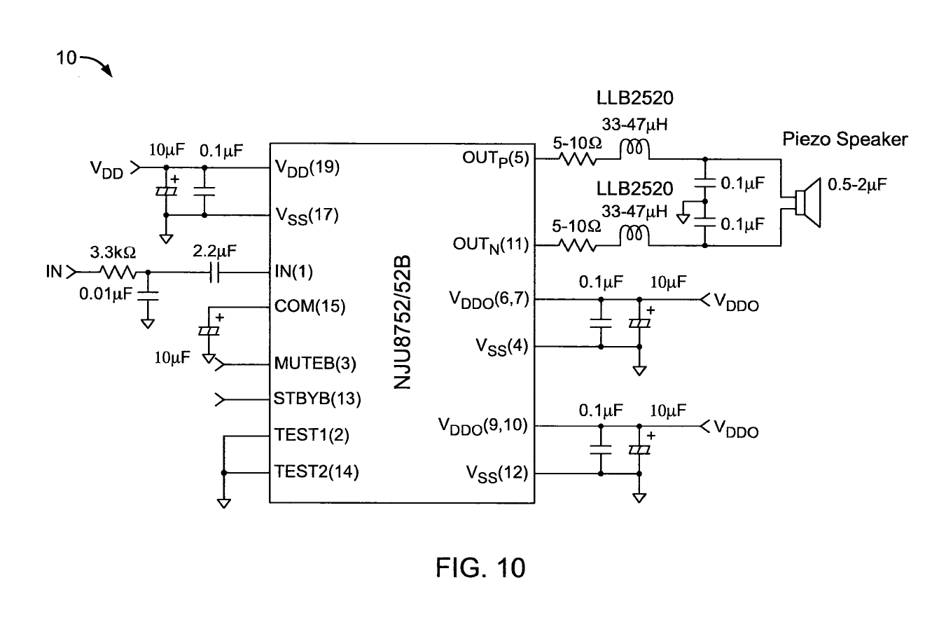

A block diagram of an example amplifier is shown in FIG. 9. The amplifier circuit includes an input 26 for receiving audio signals and an output 28 for transferring the amplified signal to the bone conducting device 2. An example of a circuit 10 in which the amplifier operates is shown in FIG. 10. The circuit can be optimized for use with a specific battery source and digital audio device to ensure a batter life of between 1 and 12 hours or more, such as between 1 and 10 hours, 1 and 8 hours, 1 and 6 hours, 1 and 4 hours, and 1 and 2 hours.

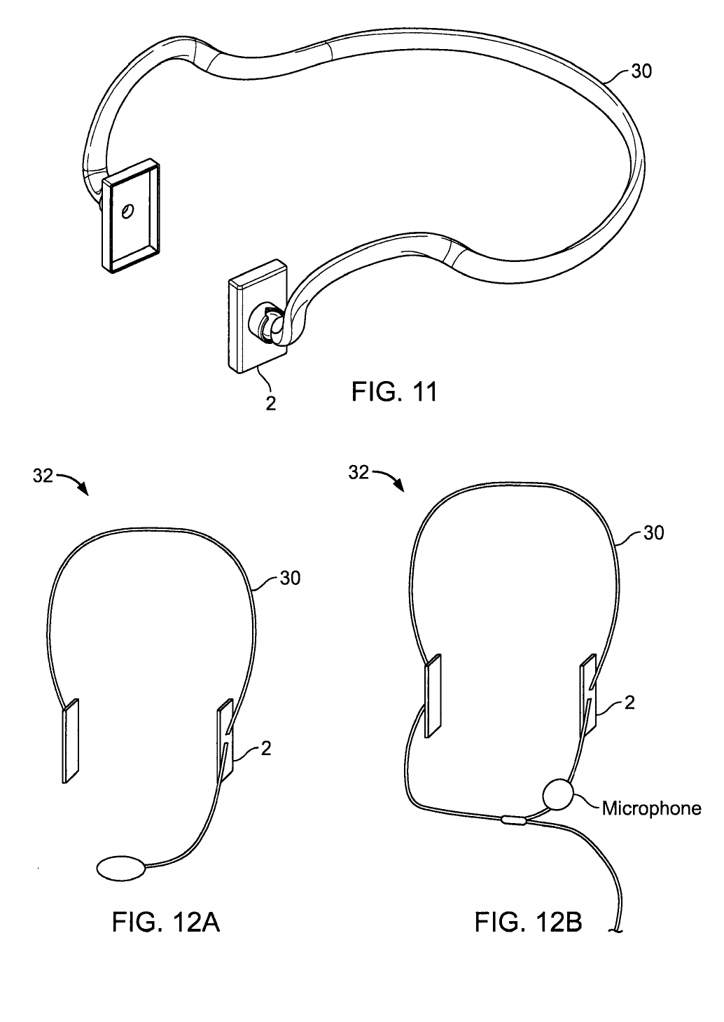

In some implementations, the bone conduction device 2 includes a coupling means 30 to secure the device 2 to the face or head of a user. For example, FIG. 11 shows an example of a coupling means 30 that is a curved piece of plastic configured to be placed over the top of or behind a user's head and in which a bone conducting device 2 attached to the coupling means is positioned on the side of a user's face adjacent to the jaw or skull. The coupling means 30 includes a spherically shaped end piece that is joined to a socket on the device 2. The socket may include multiple slots or openings into which the end piece can be joined. Accordingly, a user then can adjust the coupling means 30 to accommodate different head sizes or different placement positions on the user's head. In some implementations, the coupling means 30 can be elastic so that when it is placed on the user's head, a contracting force from the coupling means 30 secures the bone conducting device 2 in place against the user's head. In some implementations, the coupling means 30 is hook-shaped so that it rests over a user's ear. In addition, the coupling means 30 can include a clip to fix the means 30 to the user's ear.

The shape of the bone conducting device 2 is not limited to a thin plate. For example, the bone conducting device 2 can be contoured to fit against the curvature of a portion of the user's head such as the jaw or the forehead. In some implementations, the bone conducting device 2 can be formed integrally with the coupling means 30 and contoured such that it hooks over a user's ear and is located either in front of or behind the ear.

In addition the bone conducting device 2 can be integrated with headsets for special applications or uses. In some implementations, the bone conducting device 2 is integrated with communication devices. For example, FIG. 12A shows a bone conducting device that is integrated with a microphone 32 that allows a person to participate in a hands-free conversation over the communication device while, at the same time, hear ambient sounds through his or her open ear canal. FIG. 12B shows another example of a bone conducting device integrated with a microphone 32 in which the microphone 32 is in series connection with the bone conducting device 2 and the amplifier circuit 10.

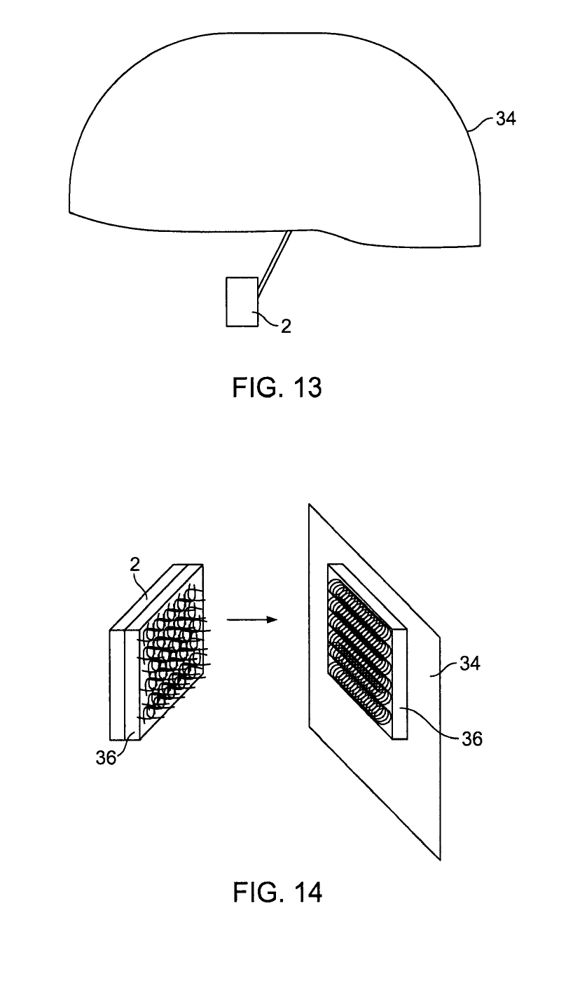

In some implementations, the bone conducting device 2 can be integrated with helmets or other headgear. For example, FIG. 13 shows a bone conducting device that is attached to and extends down from the side of a helmet 34. A flexible connecting means that is an integral and contiguous extension of the helmet 34 can be used to position the bone conducting device 2 firmly against the user's head. Examples of helmets in which the bone conducting device 2 can be integrated include, but are not limited to, a football helmet, a hockey helmet, a lacrosse helmet, a bicycle helmet, a police helmet, a motorcycle helmet, a ski helmet, hard hats, a pilot's helmet or a soldier's helmet. The bone conducting device 2 also can be integrated with headgear such as a hat, cap, or headband.

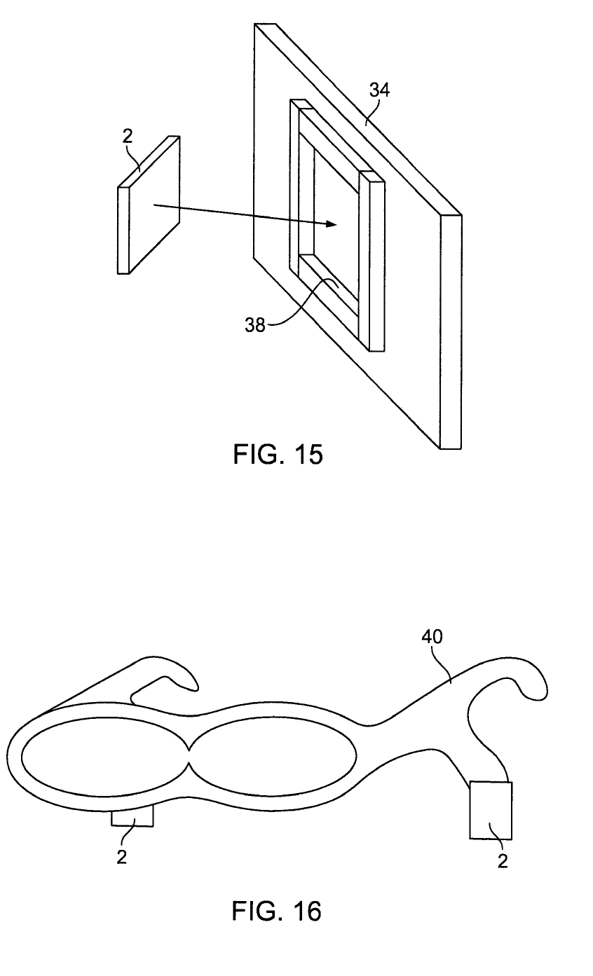

Alternatively, instead of a contiguous and integral connecting means, the bone conducting device 2 can, in some embodiments, be attached in a removable manner to helmets and other headgear. For example, FIG. 14 shows a bone conducting device 2 that is attached to the side of a helmet 34 using Velcro® tabs 36. In another example, the bone conducting device 2 is attached to a helmet 34 or other headgear by means of a receptacle 38 in which the bone conducting device 2 is secured by snapping into place and can be removed by (see FIG. 15).

In some embodiments, the bone conducting device 2 can be implemented as an integral part of or an attachment to eyewear. Examples of eyewear in which the bone conducting device 2 can be used include, but are not limited to, sunglasses, prescription eyeglasses, ski goggles, industrial and chemical safety goggles, face shields, and night vision goggles. An example of a bone conducting device 2 integrated with sunglasses 40 is shown in FIG. 16.

A bone conducting device 2 that is integrated with or attached to headgear and eyewear can be coupled to an audio device 8 using wires or wireless technology.

A number of embodiments of the invention have been described. Nevertheless, it will be understood that various modifications may be made without departing from the spirit and scope of the invention. Other embodiments are within the scope of the following claims.

What is claimed is:

1. A stereo headphone comprising:
a first audio element to be positioned against a first side of a user's head; and
a second audio element to be positioned against a second side of a user's head, wherein each of the first and second audio elements is configured to transmit audio signals through bone to an auditory system of the user.

2. The stereo headphone according to claim 1 wherein each of the first and second audio elements comprises a piezoelectric device.

3. The stereo headphone according to claim 1 further comprising an amplifier circuit wherein both of the first and second audio elements are coupled to the amplifier circuit and wherein the amplifier circuit amplifies an electrical signal received from an audio device.

4. The stereo headphone according to claim 3 wherein the amplifier circuit comprises a receiver circuit for wirelessly receiving audio signals from the audio device.

5. The stereo headphone according to claim 1 wherein the first and second audio elements are integrally connected to a helmet.

6. The stereo headphone according to claim 1 wherein the first and second audio elements are integrally connected to a hat.

7. The stereo headphone according to claim 1 wherein the first and second audio elements are integrally connected to a headband.

8. The stereo headphone according to claim 1 wherein the first and second audio elements are integrally connected with eyewear.

9. The stereo headphone according to claim 8 wherein the eyewear comprises eyeglasses.

10. The stereo headphone according to claim 8 wherein the eyewear comprises sunglasses.

11. The stereo headphone according to claim 1 wherein the eyewear comprises night-vision goggles.

12. The stereo headphone according to claim 1 wherein the first and second audio elements are configured to be removable from eyewear.

13. The stereo headphones according to claim 1 wherein the first and second audio elements are configured to be removable from a helmet, hat or headband.
